(19) United States
(12) Patent Application Publication
(10) Pub. No.: US 2019/0058324 A1
(43) Pub. Date: Feb. 21, 2019

(54) CIRCUIT FORMING METHOD AND HYDROGEN STATION

(71) Applicant: KABUSHIKI KAISHA KOBE SEIKO SHO (Kobe Steel, Ltd.), Hyogo (JP)

(72) Inventor: Masashi TAKANO, Takasago-shi (JP)

(73) Assignee: KABUSHIKI KAISHA KOBE SEIKO SHO (Kobe Steel, Ltd.), Hyogo (JP)

(21) Appl. No.: 16/059,339

(22) Filed: Aug. 9, 2018

(30) Foreign Application Priority Data
Aug. 21, 2017 (JP) 2017-158420

(51) Int. Cl. H02H 9/00; F17C 13/12; B60S 5/02; H01H 9/04; H02H 9/02

(52) U.S. Cl. CPC H02H 9/008; F17C 13/12; F17C 2221/012; H01H 9/042; H02H 9/02; B60S 5/02

(57) ABSTRACT

A circuit forming method is a method for forming a circuit in which an electrical component and an intrinsically safe explosion-proof related device are electrically connected, in a facility where the electrical component is disposed in a hazardous area and the intrinsically safe explosion-proof related device for limiting a current is disposed in a non-hazardous area. In this method, a first connector to be electrically connected to the electrical component and a second connector to be electrically connected to the intrinsically safe explosion-proof related device are connected in the hazardous area, thereby forming the circuit in which the current is limited by the intrinsically safe explosion-proof related device and grounding a shielding pin provided in the first connector or the second connector only at one position in the non-hazardous area.

### FIELD OF THE INVENTION

The present invention relates to a circuit forming method and a hydrogen station.

### BACKGROUND ART

Conventionally, it is known to form a circuit electrically connected to an electrical component disposed in a hazardous area and a control board disposed in a non-hazardous area in a facility where various combustible gases are handled as disclosed in Japanese Unexamined Patent Publication No. 2005/110271 (patent literature 1). The use of a connector in electrically connecting the electrical component such as a sensor or a valve disposed in the hazardous area and the control board disposed in the non-hazardous area is disclosed in patent literature 1.

An intrinsically safe explosion-proof circuit is known as one of explosion-proof techniques in a facility where combustible gases are handled as described above. The intrinsically safe explosion-proof circuit is an electrical circuit configured to limit energy of electric spark (arc) generated in normal time or in failure to or below ignition energy of a targeted explosive, whereby the explosion of combustible gas can be prevented. In patent literature 1, a burden of a wiring work can be reduced by using the connector, whereas there are no sufficient measures to ensure intrinsic safety of the electrical circuit in the case of applying connector connection.

### SUMMARY OF INVENTION

The present invention aims to provide a circuit forming method and a hydrogen station capable of forming an intrinsically safe explosion-proof circuit even in the case of using connector connection.

A circuit forming method according to one aspect of the present invention is a method for forming a circuit in which an electrical component and an intrinsically safe explosion-proof related device are electrically connected, in a facility where the electrical component is disposed in a hazardous area and the intrinsically safe explosion-proof related device for limiting a current is disposed in a non-hazardous area. In this method, a first connector to be electrically connected to the electrical component and a second connector to be electrically connected to the intrinsically safe explosion-proof related device are connected in the hazardous area, thereby forming the circuit in which the current is limited by the intrinsically safe explosion-proof related device and grounding a shielding pin provided in the first connector or the second connector only at one position in the non-hazardous area.

A hydrogen station according to another aspect of the present invention is provided with a hazardous area and a non-hazardous area. This hydrogen station includes an electrical component to be disposed in the hazardous area, an intrinsically safe explosion-proof related device to be disposed in the non-hazardous area and configured to limit a current, a first connector electrically connected to the electrical component and a second connector to be electrically connected to the intrinsically safe explosion-proof related device and connected to the first connector in the hazardous area. A circuit in which the electrical component and the intrinsically safe explosion-proof related device are electrically connected and a current is limited by the intrinsically safe explosion-proof related device is formed by connecting the first connector and the second connector. A shielding pin provided in the first connector or the second connector is grounded only at one position in the non-hazardous area.

According to the present invention, it is possible to provide a circuit forming method and a hydrogen station capable of forming an intrinsically safe explosion-proof circuit even in the case of using connector connection.

### BRIEF DESCRIPTION OF THE DRAWINGS

FIG. 1 schematically shows an overall configuration of a hydrogen station according to a first embodiment of the present invention.

FIG. 2 schematically shows electric wiring in a compressor unit of the hydrogen station.

FIG. 3 schematically shows the configuration of a cable with a connector on one end.

FIG. 4 is an arrow view viewed in a direction of an arrow IV in FIG. 3.

FIG. 5 shows the configuration of a cable with connectors on both ends.

FIG. 6 is an arrow view viewed in a direction of an arrow VI in FIG. 5.

FIG. 7 shows the configuration of a connector relay body.

FIG. 8 is a plan view showing the configuration of a body of the connector relay body.

FIG. 9 is a plan view showing the configuration of a lid body of the connector relay body.

FIG. 10 is a schematic diagram for explaining a hydrogen station and a circuit forming method according to a second embodiment of the present invention.

FIG. 11 schematically shows a cross-section of an attaching structure of a body and a lid body of a connector relay body in the second embodiment of the present invention.

### DESCRIPTION OF EMBODIMENTS

Hereinafter, hydrogen stations and circuit forming methods according to embodiments of the present invention are described in detail on the basis of the drawings.

### First Embodiment

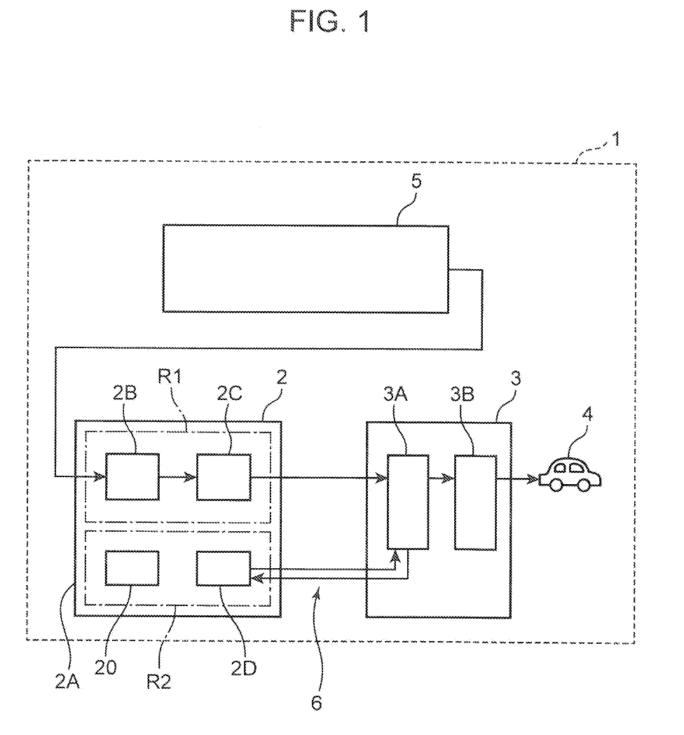

First, a hydrogen station 1 according to a first embodiment of the present invention is described. FIG. 1 schematically shows main constituent elements of the hydrogen station 1.

The hydrogen station 1 is a facility for supplying hydrogen gas as fuel into a fuel cell vehicle 4 serving as a tank mounting apparatus. The hydrogen station 1 is, for example, an on-site station and mainly includes hydrogen production equipment 5, a compressor unit 2 for compressing hydrogen gas supplied from the hydrogen production equipment 5 into a predetermined high-pressure state and a dispenser 3 for filling the high-pressure hydrogen gas supplied from the compressor unit 2 into the fuel cell vehicle 4. Note that the present invention may be applied to an off-site station for receiving hydrogen gas produced in another place without being limited to the on-site station.

The compressor unit 2 includes a housing 2A and a compressor 2B, an accumulator 2C, a freezer 2D and a control board 20 housed in the housing 2A. The compressor 2B is, for example, a compressor of a reciprocating type and boosts the hydrogen gas supplied from the hydrogen production equipment 5 by a reciprocating movement of a piston and discharges the boosted hydrogen gas. The accumulator 2C is disposed in a subsequent stage of the compressor 2B, and temporarily stores the hydrogen gas compressed into the predetermined high-pressure state by the compressor 2B.

As shown in FIG. 1, a hazardous area R1 where the compressor 2B and the accumulator 2C are disposed and a non-hazardous area R2 which is partitioned from the hazardous area R1, for example, by a wall (not shown) formed of a steel plate and where the refrigerator 2D and the control board 20 are disposed are provided in the housing 2A of the compressor unit 2.

The dispenser 3 includes a pre-cooler 3A and a dispenser body 3B. The pre-cooler 3A is, for example, a microchannel heat exchanger and cools the hydrogen gas supplied from the accumulator 2C. Specifically, the pre-cooler 3A is connected to the freezer 2D in the compressor unit 2 via a brine circulation circuit 6 and cools the hydrogen gas by utilizing the cold of brine cooled in the freezer 2D. The dispenser body 3B is disposed in a subsequent stage of the pre-cooler 3A and includes a nozzle for filling the hydrogen gas cooled by the pre-cooler 3A into the fuel cell vehicle 4.

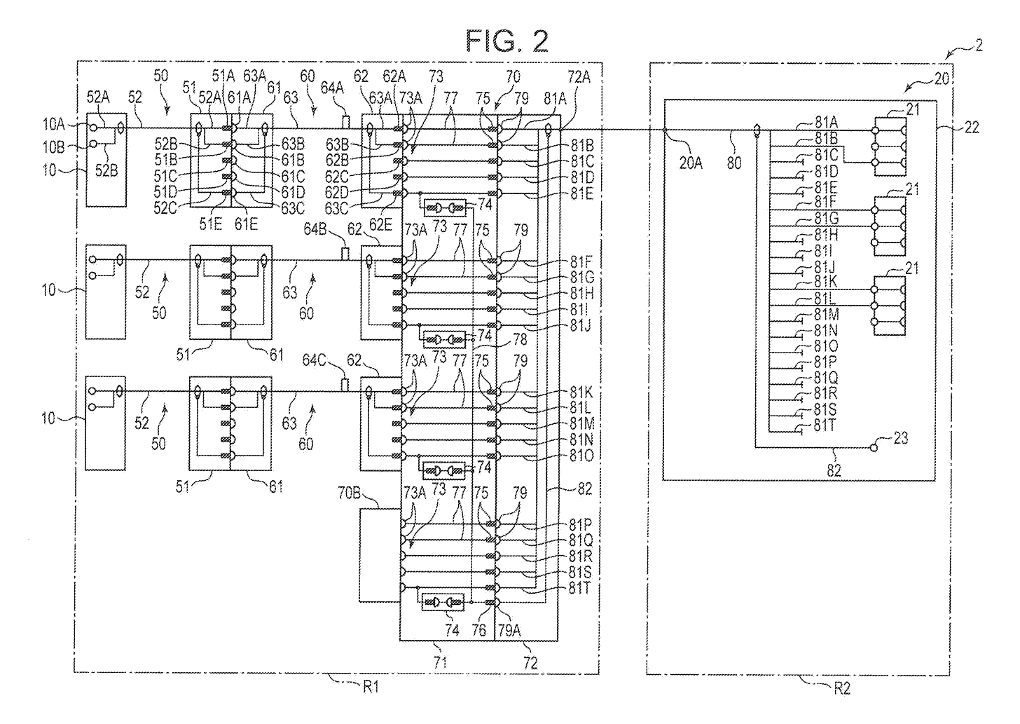

FIG. 2 schematically shows electric wiring in the housing 2A of the compressor unit 2. As shown in FIG. 2, a plurality of (three in this embodiment) electrical components 10 are disposed in the hazardous area R1, whereas the control board 20 is disposed in the non-hazardous area R2. The control board 20 includes a plurality of (three in this embodiment) intrinsically safe explosion-proof related devices 21 for limiting a current flowing in an electrical circuit to a fixed value or below.

A plurality of (three in this embodiment) cables 50 with a connector on one end, a plurality of (three in this embodiment) cables 60 with connectors on both ends, one connector relay body 70 and a cable assembly 80 are disposed as constituent elements for electrically connecting each electrical component 10 and each intrinsically safe explosion-proof related device 21 in the housing 2A of the compressor unit 2. In this embodiment, three intrinsically safe explosion-proof circuits each having a current limited by the intrinsically safe explosion-proof related device 21 are formed by connecting each of the three electrical components 10 and each of the three intrinsically safe explosion-proof related devices 21.

Note that the number of the intrinsically safe explosion-proof circuits is not particularly limited and may be two, four or more. Further, there is no limitation to the case where a plurality of intrinsically safe explosion-proof circuits are formed, and only one intrinsically safe explosion-proof circuit may be formed.

The electrical component 10 is, for example, a pressure sensor for detecting pressures of the hydrogen gas before and after being compressed, a temperature sensor for detecting a temperature of the hydrogen gas, a sensor for detecting the opening/closing of various valves provided in a circulation line of the hydrogen gas, a controller for adjusting opening degrees of various valves provided in this circulation line, a switch for detecting the circulation of cooling water for the compressor 2B (FIG. 1) or the like. Note that electrical components in the present invention are not limited to these.

The control board 20 is a device for receiving various pieces of data transmitted from the electrical components 10, supplying power to the electrical components 10 and controlling the operation of the electrical components 10. The control board 20 includes a control box 22 and a plurality of the intrinsically safe explosion-proof related devices 21 disposed in this control box 22. The intrinsically safe explosion-proof related devices 21 are devices having a function of limiting a current flowing in the electrical circuit to the fixed value or below, and circuit elements essential to form the intrinsically safe explosion-proof circuits. Further, as shown in FIG. 2, a ground contact 23 for grounding the wiring is provided in the control box 22.

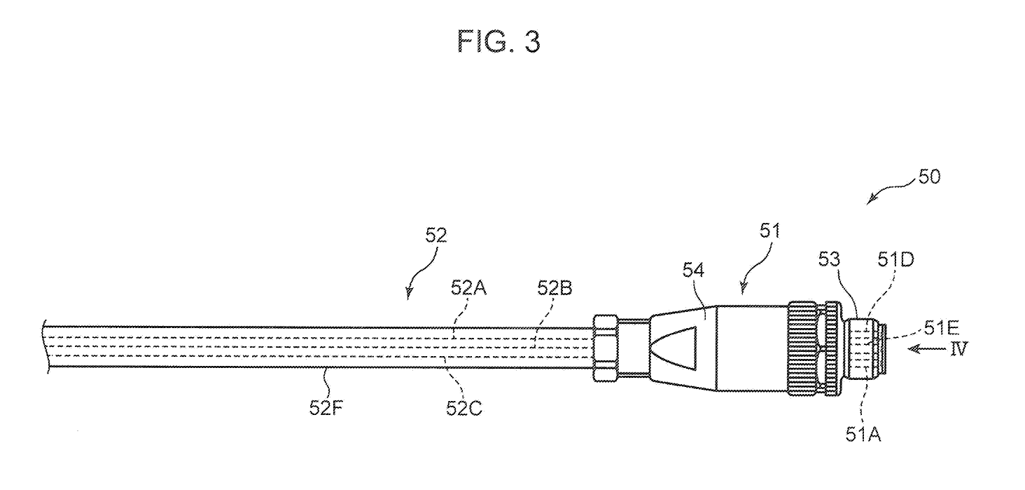

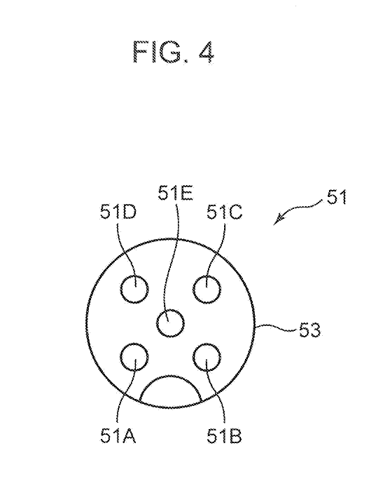

FIG. 3 shows the configuration of the cable 50 with the connector on one end. FIG. 4 shows the configuration of the cable 50 with the connector on one end viewed in a direction of an arrow IV in FIG. 3. The cable 50 with the connector on one end is disposed in the hazardous area R1 and includes a first connector 51 and a first cable 52 electrically connected to the first connector 51.

The first connector 51 is a male connector. As shown in FIG. 3, the first connector 51 includes a hollow cylindrical first connector housing 54 (housing) made of an insulating material such as resin and a first connector connecting portion 53 having a hollow cylindrical shape having a smaller diameter than the first connector housing 54 and provided on one end (end opposite to the first cable 52) of the first connector housing 54. The first connector 51 is configured to satisfy standards of IP54 or higher of C0920 of JIS (Japan Industrial Standards).

The first connector connecting portion 53 is a part to be connected to a female connector and an external thread is formed on the cylindrical outer surface thereof. Further, as shown in FIG. 4, a plurality of (five in this embodiment) connector pins 51A to 51E are provided inside the first connector connecting portion 53. The connector pins 51A to 51E are insertable into connector pin receiving portions provided in the female connector.

As shown in FIG. 3, the first cable 52 includes a first positive-side circuit line 52A, a first negative-side circuit line 52B, a first shielded wire 52C and a first sheath 52F protecting these wires and made of resin. As shown in FIG. 2, one end of the first positive-side circuit line 52A is connected to the connector pin 51A of the first connector 51. One end of the first negative-side circuit line 52B is connected to the connector pin 51B of the first connector 51. One end of the first shielded wire 52C is connected to the connector pin 51E of the first connector 51. That is, the connector pin 51E of the first connector 51 functions as a shielding pin in this embodiment.

The cable 50 with the connector on one end is electrically connected to the electrical component 10 by connecting the other end of the first positive-side circuit line 52A to a positive-side terminal 10A of the electrical component 10 and connecting the other end of the first negative-side circuit line 52B to a negative-side terminal 10B of the electrical component 10. In this way, the first connector 51 is electrically connected to the electrical component 10 via the first cable 52. That is, the connector pin 51A of the first connector 51 is connected to the positive-side terminal 10A of the electrical component 10 via the first positive-side circuit line 52A, and the connector pin 51B of the first connector 51 is connected to the negative-side terminal 10B of the electrical component 10 via the first negative-side circuit line 52B. Note that since any of the three cables 50 with the connector on one end has the same configuration and is similarly connected to each electrical component 10, the description of each cable 50 is omitted.

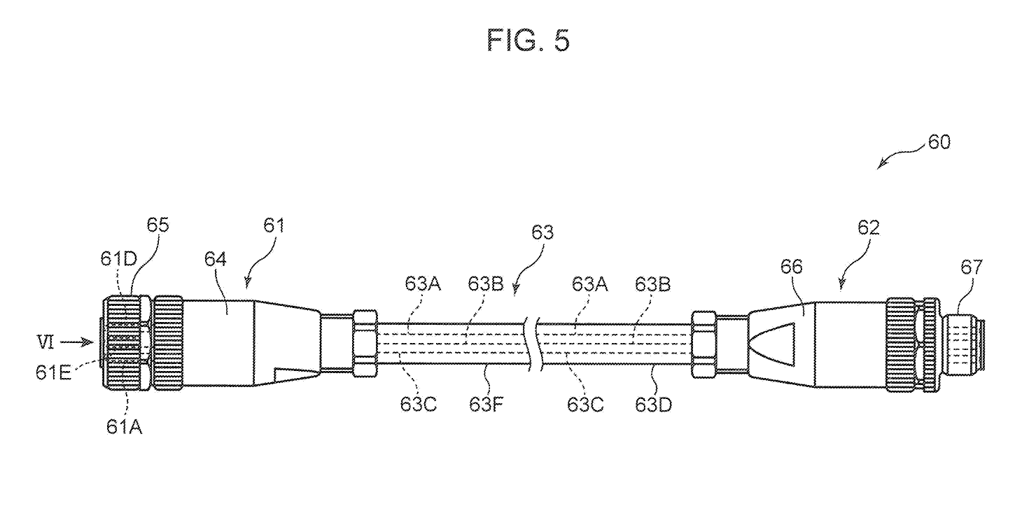

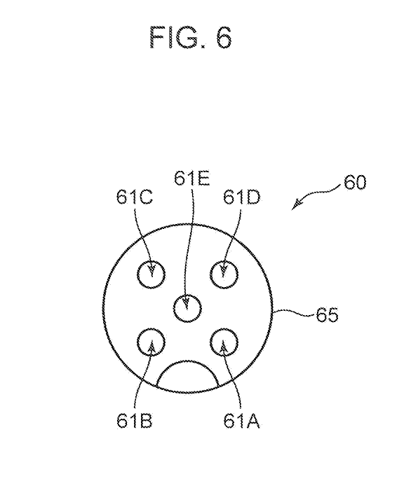

FIG. 5 shows the configuration of the cable 60 with the connectors on both ends. FIG. 6 shows the configuration of the cable 60 with the connectors on both ends viewed in a direction of an arrow VI in FIG. 5. The cable 60 with the connectors on both ends is disposed in the hazardous area R1 and includes a second connector 61, a third connector 62 and a second cable 63 connecting the second connector 61 and the third connector 62. The second connector 61 is connected to one end of the second cable 63 and the third connector 62 is connected to the other end of the second cable 63.

The second connector 61 is a female connector and connected to the first connector 51 (FIG. 3) in the hazardous area R1. As shown in FIG. 5, the second connector 61 includes a hollow cylindrical second connector housing 64 (housing) made of an insulating material such as resin and a second connector connecting portion 65 having a hollow cylindrical shape having a diameter substantially equal to that of the second connector housing 64 and provided on one end (end opposite to the second cable 63) of the second connector housing 64. The second connector 61 is configured to satisfy the standards of IP54 or higher of C0920 of JIS similarly to the first connector 51.

The second connector connecting portion 65 is a part to be connected to the first connector connecting portion 53 (FIG. 3). Specifically, the second connector connecting portion 65 is formed with an internal thread in an inner surface. By inserting the first connector connecting portion 53 into the second connector connecting portion 65 and threadably engaging the external thread and the internal thread, the first connector 51 and the second connector 61 are connected.

As shown in FIG. 6, a plurality of (five in this embodiment) connector pin receiving portions 61A to 61E are provided inside the second connector connecting portion 65. By inserting the connector pins 51A to 51E of the first connector 51 shown in FIG. 4 respectively into the connector pin receiving portions 61A to 61E, the first connector 51 and the second connector 61 are electrically connected.

The third connector 62 is a male connector connected to the second connector 61 via the second cable 63 and has the same configuration as the first connector 51 (FIG. 3). Specifically, the third connector 62 includes a third connector housing 66 (housing) made of resin and a third connector connecting portion 67 provided on one end (end opposite to the second cable 63) of the third connector connecting portion 67 and a plurality of (five in this embodiment) connector pins 62A to 62E (FIG. 2) are provided inside this third connector connecting portion 67. The third connector 62 is configured to satisfy the standards of IP54 or higher of C0920 of JIS similarly to the first and second connectors 51, 61.

The second cable 63 includes a second positive-side circuit line 63A, a second negative-side circuit line 63B, a second shielded wire 63C and a second sheath 63F protecting these wires. As shown in FIG. 2, one end of the second positive-side circuit line 63A is connected to the connector pin receiving portion 61A of the second connector 61 and the other end is connected to the connector pin 62A of the third connector 62. One end of the second negative-side circuit line 63B is connected to the connector pin receiving portion 61B of the second connector 61 and the other end is connected to the connector pin 62B of the third connector 62. One end of the second shielded wire 63C is connected to the connector pin receiving portion 61E of the second connector 61 and the other end is connected to the connector pin 62E of the third connector 62.

The three second cables 63 are respectively provided with identifying portions 64A to 64C capable of identifying each. These identifying portions 64A to 64C may be, for example, tags or markings attached to the respective cables. Note that any of the three cables 60 with the connectors on both ends has the same configuration except for the identifying portion and is similarly connected to the cable 50 with the connector on one end.

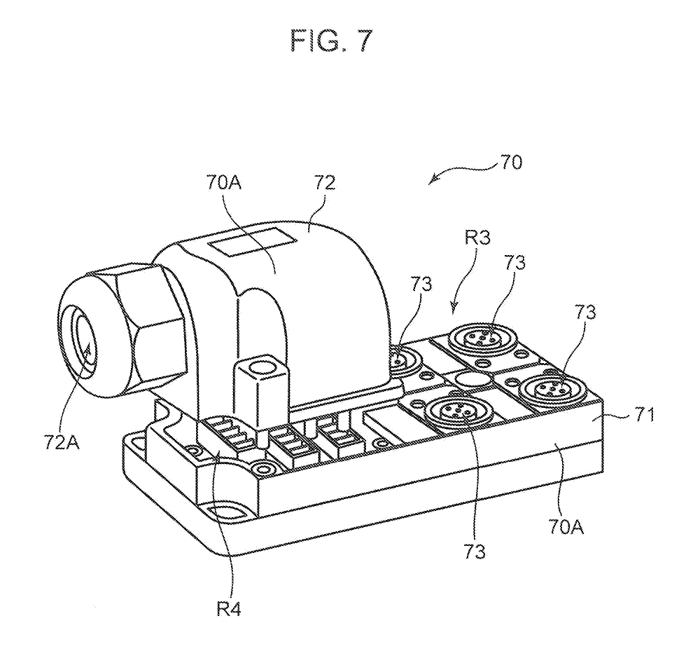

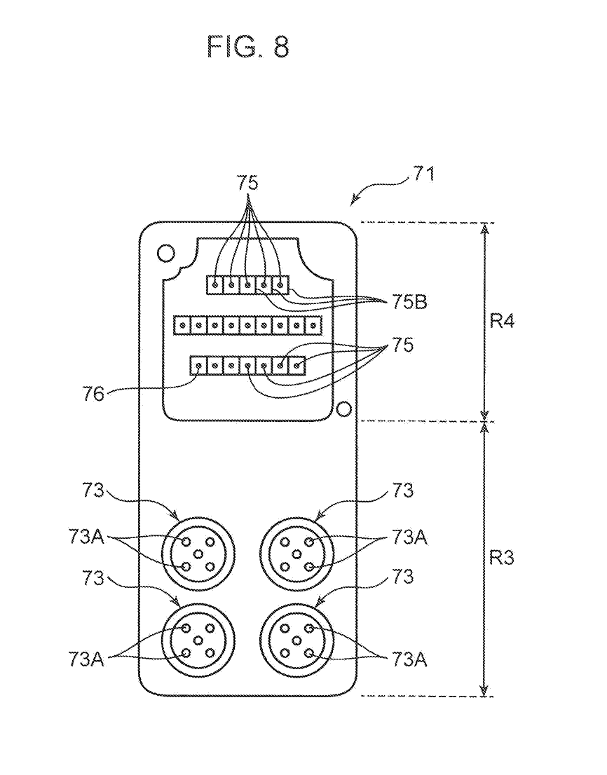

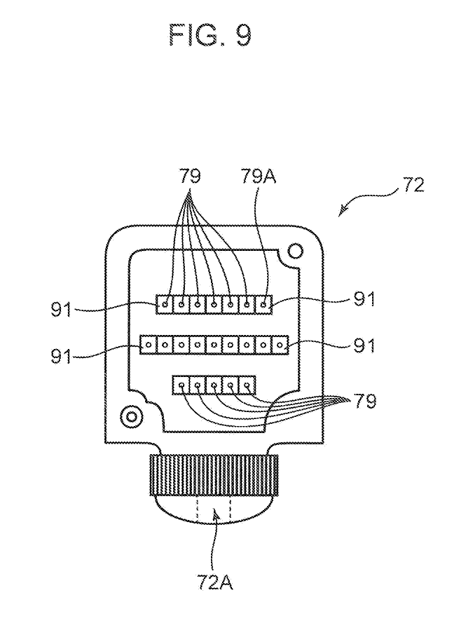

FIG. 7 shows the external appearance of the connector relay body 70. The connector relay body 70 includes a housing 70A, for example, made of an electrically insulating material such as resin, and disposed in the hazardous area R1. The connector relay body 70 includes a body 71 provided with a plurality of connector connection terminals 73 and a lid body 72 attached to the body 71 by screws. FIG. 8 is a plan view showing the configuration of the body 71. FIG. 9 is a plan view showing the configuration of the lid body 72. The connector relay body 70 is configured to satisfy standards of IP54 or higher of C0920 of JIS similarly to the first to third connectors 51, 61 and 62.

As shown in FIG. 7, the body 71 has a substantially rectangular parallelepiped shape. As shown in FIG. 8, one side (lower side in FIG. 8) of the body 71 in a length direction serves as a connector connection region R3 where the plurality of connector connection terminals 73 are provided, and the other side (upper side in FIG. 8) of the body 71 in the length direction serves as an attached region R4 where the lid body 72 is attached. The connector connection terminal 73 is a part to be connected to the third connector 62. In this embodiment, four connector connection terminals 73 are provided. Note that since three third connectors 62 are used in this embodiment, a cap 70B (see FIG. 2) is mounted on one unused connector connection terminal 73.

As shown in FIG. 2, each connector connection terminal 73 includes five pin receiving portions 73A. By inserting the respective connector pins 62A to 62E of the third connector 62 into these five pin receiving portions 73A, each of the plurality of third connectors 62 is connected to the respective connector connection terminals 73. Since four connector connection terminals 73 are provided in this embodiment, there are a total of twenty pin receiving portions 73A.

The body 71 includes intermediate pins 75 electrically connected to the respective pin receiving portions 73A via internal wires 77. As many intermediate pins 75 as the pin receiving portions 73A (twenty) are provided, and each intermediate pin 75 is electrically connected to one pin receiving portion 73A. As shown in FIG. 8, twenty intermediate pins 75 are provided in the attached region R4 of the body 71.

The body 71 includes one shielding intermediate pin 76 adjacent to the intermediate pins 75. As shown in FIG. 8, this shielding intermediate pin 76 is provided in the attached region R4 of the body 71 similarly to the twenty intermediate pins 75. As shown in FIG. 2, the pin receiving portions 73A having the connector pins 62E inserted therein in each connector connection terminal 73 are connected to the shielding intermediate pin 76 via bridges 74 and an internal shielded wire 78.

The lid body 72 includes a plurality of (twenty in this embodiment) intermediate pin receiving portions 79 and one shielding intermediate pin receiving portion 79A. The lid body 72 is attached in the attached region R4 of the body 71 in a state where the twenty intermediate pins 75 are respectively inserted in the intermediate pin receiving portions 79 and the one shielding intermediate pin 76 is inserted in the shielding intermediate pin receiving portion 79A. Further, the lid body 72 is provided with a wiring port 72A through which the cable assembly 80 is passed.

The cable assembly 80 is for electrically connecting the connector relay body 70 and the plurality of intrinsically safe explosion-proof related devices 21. The cable assembly 80 includes a plurality of (twenty in this embodiment) wires 81A to 81T and one shielded wire 82, and is formed by bundling these wires between the connector relay body 70 and the intrinsically safe explosion-proof related devices 21. As described above, in this embodiment, three intrinsically safe explosion-proof circuits are formed, each of a pair of the wires 81A and 81B, a pair of the wires 81F and 81G and a pair of the wires 81K and 81L corresponds to one intrinsically safe explosion-proof circuit.

As shown in FIG. 2, one end of the cable assembly 80 is introduced into the lid body 72 of the connector relay body 70 through the wiring port 72A. In the lid body 72, the cable assembly 80 is split into twenty wires 81A to 81T and one shielded wire 82. Each wire 81A to 81T is connected to each of the twenty intermediate pin receiving portions 79 in the lid body 72, and the shielded wire 82 is connected to the one shielding intermediate pin receiving portion 79A in the lid body 72.

On the other hand, the other end of the cable assembly 80 is introduced into the control box 22 through the wiring port 20A. In the control box 22, the cable assembly 80 is split into twenty wires 81A to 81T and one shielded wire 82. As shown in FIG. 2, the pair of the wires 81A and 81B, the pair of the wires 81F and 81G and the pair of the wires 81K and 81L are respectively connected to the positive/negative terminals of the three intrinsically safe explosion-proof related devices 21. In this way, the second connector 61 is electrically connected to the intrinsically safe explosion-proof related device 21 successively via the second cable 63, the third connector 62, the connector relay body 70 and the cable assembly 80. Further, as shown in FIG. 2, the one shielded wire 82 is connected to the ground contact 23 provided in the control box 22.

In this embodiment, by connecting the first connectors 51 electrically connected to the electronical components 10 and the second connectors 61 electrically connected to the intrinsically safe explosion-proof related devices 21, a plurality of (three) intrinsically safe explosion-proof circuits are formed in which the electronical components 10 and the intrinsically safe explosion-proof related devices 21 are electrically connected and currents are limited by the intrinsically safe explosion-proof related devices 21. In each intrinsically safe explosion-proof circuit, one electronical component 10 is electrically connected to one intrinsically safe explosion-proof related device 21 successively via one first cable 52, one first connector 51, one second connector 61, one second cable 63, one third connector 62, the connector relay body 70 and the cable assembly 80. That is, each of the plurality of intrinsically safe explosion-proof circuits is formed by connecting one of the plurality of first connectors 51 and one of the plurality of second connectors 61.

Further, the connector pin 51E (shielding pin) of the first connector 51 is grounded only at one position (ground contact 23) of the control board successively via the connector pin receiving portion 61E of the second connector 61, the second shielded wire 63C of the second cable 63, the connector pin 62E of the third connector 62, the connector relay body 70 and the shielded wire 82 of the cable assembly 80.

Next, a circuit forming method according to this embodiment is described. This circuit forming method is a method for forming the intrinsically safe explosion-proof circuit in which the electronical component 10 and the intrinsically safe explosion-proof related device 21 are electrically connected, in the above hydrogen station 1.

First, a plurality of (three) cables 50 with the connector on one end (FIG. 3), a plurality of (three) cables 60 with the connectors on both ends (FIG. 5), one connector relay body 70 (FIG. 7) and one cable assembly 80 are respectively prepared.

Subsequently, as shown in FIG. 2, the connector relay body 70 is disposed in the hazardous area RE Then, one end of the cable assembly 80 is introduced into the lid body 72 through the wiring port 72A. Then, the cable assembly 80 is split in the lid body 72, the wires 81A to 81T are respectively connected to the intermediate pin receiving portions 79 of the lid body 72 and the shielded wire 82 is connected to the shielding intermediate pin receiving portion 79A of the lid body 72.

Subsequently, the other end of the cable assembly 80 is introduced into the control box 22 through the wiring port 20A. Then, the cable assembly 80 is split in the control box 22, and the pair of the wires 81A and 81B, the pair of the wires 81F and 81G and the pair of the wires 81K and 81L are respectively connected to the positive/negative terminals of the three intrinsically safe explosion-proof related devices 21. In this way, the connector relay body 70 and the plurality of intrinsically safe explosion-proof related devices 21 are electrically connected by the cable assembly 80. Further, the shielded wire 82 is connected to the ground contact 23 in the control box 22.

Subsequently, the third connectors 62 of the plurality of cables 60 with the connectors on both ends are respectively connected to the connector connection terminals 73 of the connector relay body 70. Specifically, the connector pins 62A to 62E of the third connector 62 are respectively inserted into the five pin receiving portions 73A of the connector connection terminal 73. In this way, the second connector 61 is electrically connected to the intrinsically safe explosion-proof related device 21 successively via the second cable 63, the third connector 62, the connector relay body 70 and the cable assembly 80.

Subsequently, the first positive-side circuit lines 52A of the cables 50 with the connector on one end are connected to the positive-side terminals 10A of the electronical components 10 and the first negative-side circuit lines 52B thereof are connected to the negative-side terminals 10B of the electronical components 10. In this way, the first connectors 51 are electrically connected to the electronical components 10 via the first cables 52.

Finally, the first connectors 51 of the cables 50 with the connector on one end and the second connectors 61 of the cables 60 with the connectors on both ends are connected in the hazardous area R1. Specifically, the connector pins 51A to 51E of the first connectors 51 are respectively inserted into the connector pin receiving portions 61A to 61E of the second connectors 61.

By the above procedure, three intrinsically safe explosion-proof circuits can be formed in which currents are limited by the intrinsically safe explosion-proof related devices 21. In this embodiment, each of the intrinsically safe explosion-proof circuits is formed one by one by connecting one of the three first connectors 51 and one of the three second connectors 61. Further, the connector pin (shielding pin) 51E of the first connector 51 is grounded only at one position (ground contact 23) successively via the connector pin receiving portion 61E of the second connector 61, the second shielded wire 63C of the second cable 63, the connector pin 62E of the third connector 62, the connector relay body 70 and the shielded wire 82 of the cable assembly 80.

Note that a connection order of the first to third connectors 51, 61 and 62, the connector relay body 70 and the cable assembly 80 is not limited to the above one. For example, after the connector relay body 70 and the intrinsically safe explosion-proof related devices 21 are connected by the cable assembly 80, the third connectors 62 may be connected to the connector relay body 70, the first connectors 51 and the second connectors 61 may be then connected and the first cables 52 may be finally connected to the electronical components 10. Further, after the first cables 52 are connected to the electronical components 10, the first connectors 51 and the second connectors 61 may be connected, the third connectors 62 may be then connected to the connector relay body 70 and the connector relay body 70 and the intrinsically safe explosion-proof related devices 21 may be finally connected by the cable assembly 80. Besides these, various connection procedures can be adopted.

Here, features, functions and effects of the circuit forming method and the hydrogen station according to the first embodiment described above are listed.

The circuit forming method according to the first embodiment is a method for forming the circuit in which the electronical component 10 and the intrinsically safe explosion-proof related device 21 are electrically connected, in the hydrogen station 1 (facility) in which the electronical component 10 is disposed in the hazardous area R1 and the intrinsically safe explosion-proof related device 21 for limiting a current is disposed in the non-hazardous area R2. This method is a method for forming a circuit in which a current is limited by the intrinsically safe explosion-proof related device 21 and grounding the connector pin 51E (shielding pin) provided in the first connector 51 only at one position in the non-hazardous area R2 by connecting the first connector 51 to be electrically connected to the electrical component 10 and the second connector 61 to be electrically connected to the intrinsically safe explosion-proof related device 21 in the hazardous area R1.

The hydrogen station 1 according to the first embodiment is provided with the hazardous area R1 and the non-hazardous area R2. This hydrogen station 1 includes the electrical component 10 to be disposed in the hazardous area R1, the intrinsically safe explosion-proof related device 21 to be disposed in the non-hazardous area R2 and configured to limit a current, the first connector 51 electrically connected to the electrical component 10 and the second connector 61 to be electrically connected to the intrinsically safe explosion-proof related device 21 and connected to the first connector 51 in the hazardous area R1. By connecting the first connector 51 and the second connector 61, the circuit is formed in which the electrical component 10 and the intrinsically safe explosion-proof related device 21 are electrically connected and the current is limited by the intrinsically safe explosion-proof related device 21. The connector pin 51E (shielding pin) provided in the first connector 51 is grounded only at one position in the non-hazardous area R2.

According to this feature, the intrinsically safe explosion-proof circuit in which the current is limited by the intrinsically safe explosion-proof related device 21 can be formed by connector connection. Thus, man-hours in a wiring work can be reduced as compared to the case where crimping terminals, terminal blocks or the like are used. By grounding the connector pin 51E (shielding pin) provided in the first connector 51 only at one position in the non-hazardous area R2, the generation of a circulating current can be prevented unlike in the case of grounding on both ends. Thus, the generation of an arc due to the circulating current is prevented, wherefore the intrinsically safe explosion-proof circuit can be formed even in the case of using connector connection.

In the above circuit forming method, each of the plurality of circuits is formed by connecting one of the plurality of first connectors 51 and one of the plurality of second connectors 61.

The above hydrogen station 1 includes the plurality of electrical components 10, the plurality of intrinsically safe explosion-proof related devices 21, the plurality of first connectors 51 and the plurality of second connectors 61. By connecting each of the plurality of electrical components 10 and each of the plurality of intrinsically safe explosion-proof related devices 21, a plurality of circuits are formed. Each of the plurality of circuits is formed by connecting one of the plurality of first connectors 51 and one of the plurality of second connectors 61.

According to this feature, since a different connector connection can be used for each intrinsically safe explosion-proof circuit, the shorting of the intrinsically safe explosion-proof circuits can be reliably prevented as compared to the case where a plurality of intrinsically safe explosion-proof circuits are formed by one connector connection.

In the above circuit forming method, the connector relay body 70 provided with the plurality of connector connection terminals 73 is disposed in the hazardous area R1. The plurality of third connectors 62 respectively connected to the plurality of second connectors 61 via the second cables 63 are respectively connected to the plurality of connector connection terminals 73 provided in the connector relay body 70. The connector relay body 70 and the plurality of intrinsically safe explosion-proof related devices 21 are electrically connected by the cable assembly 80 formed by bundling the plurality of wires 81A, 81B, 81F, 81G, 81K and 81L respectively corresponding to the plurality of circuits.

The above hydrogen station 1 includes the connector relay body 70 provided with the plurality of connector connection terminals 73 and disposed in the hazardous area R1, the plurality of third connectors 62 to be respectively connected to the plurality of second connectors 61 via the second cables 63 and respectively connected to the plurality of connector connection terminals 73 provided in the connector relay body 70 and the cable assembly 80 configured to electrically connect the connector relay body 70 and the plurality of intrinsically safe explosion-proof related devices 21 and formed by bundling the plurality of wires 81A, 81B, 81F, 81G, 81K and 81L respectively corresponding to the plurality of circuits between the connector relay body 70 and the intrinsically safe explosion-proof related devices 21.

According to this feature, the complication of the wiring between the connector relay body 70 and the intrinsically safe explosion-proof related devices 21 can be prevented even in the case of forming the plurality of intrinsically safe explosion-proof circuits.

In the above circuit forming method, the plurality of second cables 63 are used which are provided with the identifying portions 64A to 64C capable of identifying each.

In the above hydrogen station 1, the plurality of second cables 63 for connecting the plurality of second connectors 61 and the plurality of third connectors 62 are provided with the identifying portions 64A to 64C capable of identifying each.

According to this feature, erroneous connection can be prevented by using the identifying portions 64A to 64C as marks in respectively connecting the plurality of third connectors 62 to the connector connection terminals 73 of the connector relay body 70.

In the above circuit forming method, the first connectors 51, the second connectors 61, the third connectors 62 and the connector relay body 70 are used which include the housings 54, 64, 66 and 70A made of the electrically insulating material.

In the above hydrogen station 1, the first connectors 51, the second connectors 61, the third connectors 62 and the connector relay body 70 include the housings 54, 64, 66 and 70A made of the electrically insulating material.

According to this feature, it is possible to prevent shields from being grounded in the connector relay body 70 and reliably ground the shields only at one position in the non-hazardous area R2.

In the above circuit forming method, the connector relay body 70, the first connectors 51, the second connectors 61 and the third connectors 62 are used which satisfy the standards of IP54 or higher.

In the above hydrogen station 1, the connector relay body 70, the first connectors 51, the second connectors 61 and the third connectors 62 satisfy the standards of IP54 or higher.

According to this feature, since the intrusion of dust and moisture into the connector relay body 70 and each connector can be prevented, the intrinsically safe explosion-proof circuits can be reliably formed.

### Second Embodiment

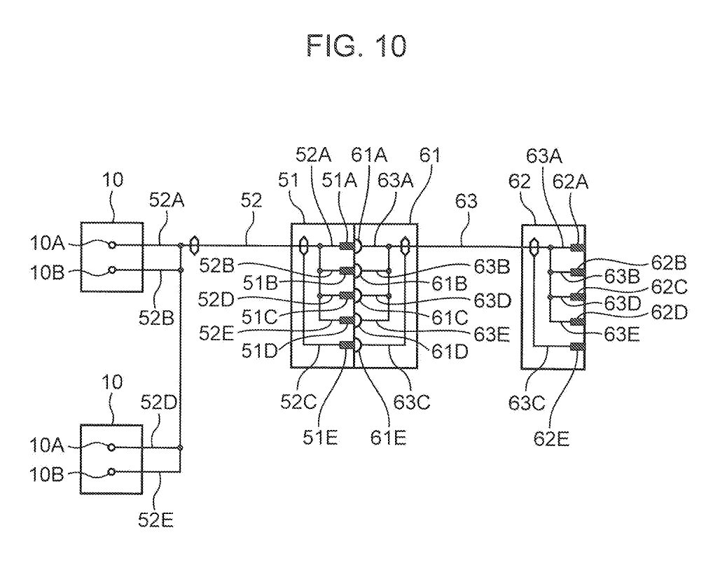

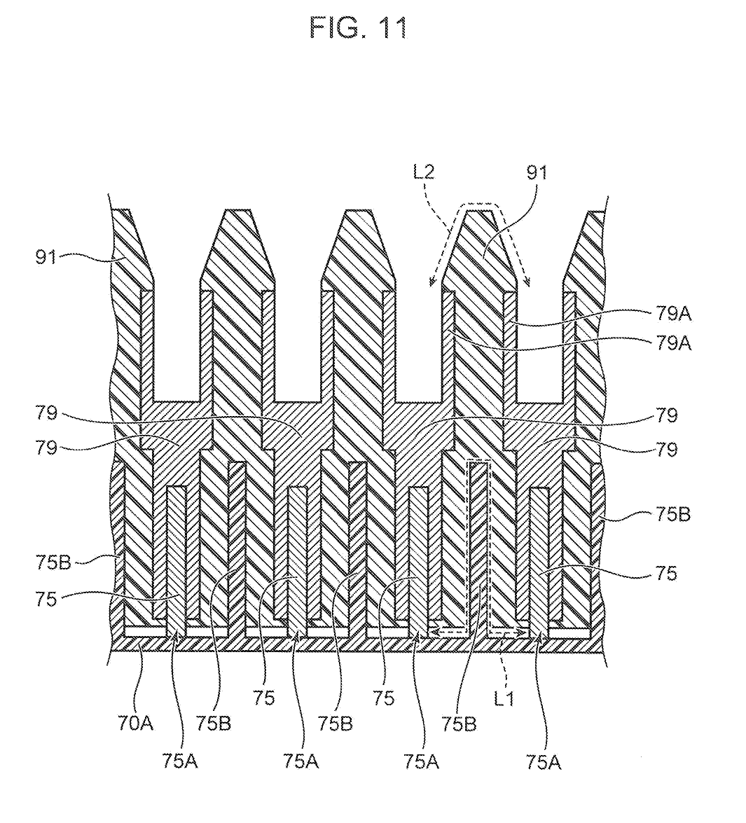

Next, a circuit forming method and a hydrogen station according to a second embodiment of the present invention are described with reference to FIGS. 10 and 11. The second embodiment is basically similar to the above first embodiment, but differs from the above first embodiment in that a plurality of intrinsically safe explosion-proof circuits are formed by connecting one first connector 51 and one second connector 61. Only points of difference from the above first embodiment are described below.

As shown in FIG. 10, a first cable 52 includes, in addition to one first positive-side circuit line 52A, one first negative-side circuit line 52B and one first shielded wire 52C described in the above first embodiment, another first positive-side circuit line 52D and another first negative-side circuit line 52E. Note that a connector relay body 70, a cable assembly 80 and a control board 20 are not shown in FIG. 10.

One end of the first positive-side circuit line 52D is connected to a connector pin 51C of the first connector 51, and the other end is connected to a positive-side terminal 10A of an electrical component 10 (electrical component 10 different from an electrical component 10 connected to the circuit lines 52A, 52B). One end of the first negative-side circuit line 52E is connected to a connector pin 51D of the first connector 51 and the other end is connected to a negative-side terminal 10B of this electrical component 10. That is, unlike the above first embodiment, wiring is connected to all connector pins 51A to 51E of the first connector 51.

The second cable 63 includes, in addition to one second positive-side circuit line 63A, one second negative-side circuit line 63B and one second shielded wire 63C described in the above first embodiment, another second positive-side circuit line 63D and another second negative-side circuit line 63E.

One end of the second positive-side circuit line 63D is connected to a connector pin receiving portion 61C of the second connector 61, and the other end is connected to a connector pin 62C of a third connector 62. One end of the second negative-side circuit line 63E is connected to a connector pin receiving portion 61D of the second connector 61 and the other end is connected to a connector pin 62D of the third connector 62. That is, unlike the above first embodiment, wiring is connected to all connector pin receiving portions 61A to 61E of the second connector 61 and all connector pins 62A to 62E of the third connector 62.

In the second embodiment, a plurality of (two) intrinsically safe explosion-proof circuits are formed by connecting one first connector 51 and one second connector 61. That is, the circuit lines 52A, 52B, 63A, 63B correspond to one intrinsically safe explosion-proof circuit and the circuit lines 52D, 52E, 63D and 63E correspond to the other intrinsically safe explosion-proof circuit.

In the case of forming a plurality of intrinsically safe explosion-proof circuits by one connector connection in this way, the shorting of the intrinsically safe explosion-proof circuits in the connectors becomes problematic unlike in the case of applying a different connector connection for each intrinsically safe explosion-proof circuit as in the above first embodiment. Thus, in the second embodiment, shortest distances between bare exposed parts of the connector pins included in one intrinsically safe explosion-proof circuit and those of the connector pins included in the other intrinsically safe explosion-proof circuit are 6 mm or longer in the first connector 51. Note that the “bare exposed part” is a part of the connector pin where a metal part is exposed.

Specifically, in the first connector 51, the connector pins 51A, 51B correspond to one intrinsically safe explosion-proof circuit and the connector pins 51C, 51D correspond to the other intrinsically safe explosion-proof circuit. Thus, the shortest distances from the bare exposed part of the connector pin 51A to those of the respective connector pins 51C, 51D are 6 mm or longer. Further, the shortest distances from the bare exposed part of the connector pin 51B to those of the respective connector pins 51C, 51D are also 6 mm or longer.

Note that it is not necessary to ensure a shortest distance (may be a shortest distance as a creepage distance) of 6 mm or longer between the bare exposed parts of the connector pins corresponding to one intrinsically safe explosion-proof circuit. This is because a current can be limited to a fixed value or lower by an intrinsically safe explosion-proof related device 21 even if a short circuit occurs in one intrinsically safe explosion-proof circuit. Thus, the shortest distance between the bare exposed part of the connector pin 51A and that of the connector pin 51B may be shorter than 6 mm Further, the shortest distance between the bare exposed part of the connector pin 51C and that of the connector pin 51D may be shorter than 6 mm

Further, in the second connector 61, the connector pin receiving portions 61A, 61B correspond to one intrinsically safe explosion-proof circuit and the connector pin receiving portions 61C, 61D correspond to the other intrinsically safe explosion-proof circuit. Thus, the shortest distances from the bare exposed part of the connector pin receiving portion 61A to those of the respective connector pin receiving portions 61C, 61D are 6 mm or longer. Further, the shortest distances from the bare exposed part of the connector pin receiving portion 61B to those of the respective connector pin receiving portions 61C, 61D are also 6 mm or longer.

Further, also in the third connector 62, shortest distances (may be shortest distances as creepage distances) between bare exposed parts of the connector pins corresponding to the two intrinsically safe explosion-proof circuits are 6 mm or longer. In the third connector 62, the connector pins 62A, 62B correspond to one intrinsically safe explosion-proof circuit and the connector pins 62C, 62D correspond to the other intrinsically safe explosion-proof circuit. Thus, the shortest distances from the bare exposed part of the connector pin 62A to those of the respective connector pins 62C, 62D may be 6 mm or longer. Further, the shortest distances from the bare exposed part of the connector pin 62B to those of the respective connector pins 62C, 62D may also be 6 mm or longer.

Further, also in the connector relay body 70 (FIG. 7), shortest distances (creepage distances) between bare exposed parts of pins and pin receiving portions corresponding to the two intrinsically safe explosion-proof circuits are ensured to be 6 mm or longer as described below.

First, in one connector connection terminal 73 shown in FIG. 2, two pin receiving portions 73A into which the connector pins 62A, 62B of the third connector 62 are to be inserted correspond to one intrinsically safe explosion-proof circuit, and two pin receiving portions 73A into which the connector pins 62C, 62D are to be inserted correspond to the other intrinsically safe explosion-proof circuit. Thus, shortest distances (creepage distances) from bare exposed parts of the pin receiving portions 73A into which the connector pins 62A, 62B are to be inserted to those of the pin receiving portions 73A into which the connector pins 62C, 62D are to be inserted are 6 mm or longer.

FIG. 11 is a sectional view of an attached part of a body 71 and a lid body 72 in the connector relay body 70 showing a state where each intermediate pin 75 of the body 71 is inserted in each intermediate pin receiving portion 79 of the lid body 72. As shown in FIG. 11, the respective intermediate pins 75 stand perpendicularly from the bottom surface of a housing 70A and are partitioned from each other by partition walls 75B made of an electrically insulating material such as resin. Further, the respective intermediate pin receiving portions 79 are attached to terminal housings 91 made of an electrically insulating material such as resin and the partition walls 75B are fitted into the terminal housings 91.

Each intermediate pin 75 includes a bare exposed part 75A which is a part (base end part) connected to the bottom surface of the housing 70A. In FIG. 11, the first intermediate pin 75 from right corresponds to one intrinsically safe explosion-proof circuit and the intermediate pin 75 adjacent to the first intermediate pin (second intermediate pin 75 from right) corresponds to the other intrinsically safe explosion-proof circuit. A shortest distance between the bare exposed parts 75A of these intermediate pins 75 is a creepage distance extending along the bottom surface of the housing 70A and side surfaces of the partition wall 75B as indicated by an arrow L1, and this distance is ensured to be 6 mm or longer.

Further, each intermediate pin receiving portion 79 also includes a bare exposed part 79A where a metal part is exposed. In FIG. 11, the first intermediate pin receiving portion 79 from right corresponds to one intrinsically safe explosion-proof circuit and the intermediate pin receiving portion 79 adjacent to the first intermediate pin receiving portion (second intermediate pin receiving portion 79 from right) corresponds to the other intrinsically safe explosion-proof circuit. A shortest distance between the bare exposed parts 79A of these intermediate pin receiving portions 79 is a creepage distance extending along the surface of the terminal housing 91 as indicated by an arrow L2, and this distance is ensured to be 6 mm or longer.

In the second embodiment, even in the case of forming a plurality of intrinsically safe explosion-proof circuits by one connector connection, the shorting of the intrinsically safe explosion-proof circuits can be prevented by separating the bare exposed parts of the connector pins and the connector pin receiving portions corresponding to the respective circuits in the connectors and the connector relay body 70. Thus, a plurality of intrinsically safe explosion-proof circuits can be formed using a small number of connectors.

### Other Embodiments

Here, other embodiments of the present invention are described.

Although the first connectors 51 are male connectors and the second connectors 61 are female connectors in the above first embodiment, the first connectors 51 may be female connectors and the second connectors 61 may be male connectors. In this case, one connector pin of the second connector 61 serves as a shielding pin and is grounded only at one position (ground contact 23) in the control board 20 as in the case of the above first embodiment.

Although the area where the compressor 2B and the accumulator 2C are disposed in the housing 2A of the compressor unit 2 is described as an example of the hazardous area in the above first embodiment, there is no limitation to this. Other examples of the hazardous area include, for example, an area near the dispenser 3. Further, the present invention is not limited to the formation of an electrical circuit between a hazardous area and a non-hazardous area in a hydrogen station, and can be applied to the formation of an electrical circuit in another facility such as a petrochemical plant.

In the above first embodiment, the connector relay body 70 and the cable assembly 80 may be omitted and the plurality of second cables 63 may be drawn to the non-hazardous area R2 and respectively directly connected to the plurality of intrinsically safe explosion-proof related devices 21.

In the above first embodiment, the first cables 52 may be omitted and the first connectors 51 may be directly connected to the electrical components 10.

In the above first embodiment, the identifying portions 64A to 64C respectively provided on the plurality of second cables 63 may be omitted.

Although all of the connector relay body 70 and the first to third connectors 51, 61 and 62 satisfy the standards of IP54 or higher in the above first embodiment, only one, two or three of these may satisfy the standards of IP54 or higher.

Although the shielding pin is grounded only at one position (ground contact 23) in the control board 20 in the above first embodiment, there is no limitation to this and the shielding pin may be grounded only at one position in the non-hazardous area R2 (one position outside the control board 20 in the non-hazardous area R2). Further, although the intrinsically safe explosion-proof related devices 21 are arranged in the control board 20, there is no limitation to this and the intrinsically safe explosion-proof related devices 21 may be arranged outside the control board 20 in the non-hazardous area R2.

Note that the above embodiments are summarized as follows.

A circuit forming method according to the above embodiment is a method for forming a circuit in which an electrical component and an intrinsically safe explosion-proof related device are electrically connected, in a facility where the electrical component is disposed in a hazardous area and the intrinsically safe explosion-proof related device for limiting a current is disposed in a non-hazardous area. In this method, a first connector to be electrically connected to the electrical component and a second connector to be electrically connected to the intrinsically safe explosion-proof related device are connected in the hazardous area, thereby forming the circuit in which the current is limited by the intrinsically safe explosion-proof related device and grounding a shielding pin provided in the first connector or the second connector only at one position in the non-hazardous area.

According to this method, since the intrinsically safe explosion-proof circuit in which the current is limited by the intrinsically safe explosion-proof related device can be formed by connector connection, man-hours in a wiring work can be reduced as compared to the case of using crimping terminals, terminal blocks or the like. By grounding the shielding pin provided in the connector only at one position in the non-hazardous area, the generation of a circulating current can be prevented unlike in the case of grounding on both ends. Thus, the generation of an arc due to the circulating current is prevented, wherefore the intrinsically safe explosion-proof circuit can be formed even in the case of using connector connection.

Here, the “intrinsically safe explosion-proof related device” is a device necessary to form the intrinsically safe explosion-proof circuit, and a circuit element having a function of limiting a current flowing in an electrical circuit to a fixed value or lower.

In the above circuit forming method, each of a plurality of the circuits may be formed by connecting one of a plurality of the first connectors and one of a plurality of the second connectors.

Since a different connector connection can be used for each intrinsically safe explosion-proof circuit in this way, the shorting of the intrinsically safe explosion-proof circuits can be reliably prevented as compared to the case where a plurality of intrinsically safe explosion-proof circuits are formed by one connector connection.

In the above circuit forming method, a plurality of the circuits may be formed by connecting one first connector and one second connector. The first connector or the second connector in which a shortest distance between bare exposed parts of connector pins respectively corresponding to a plurality of the circuits is 6 mm or longer may be used.

In this way, the shorting of the intrinsically safe explosion-proof circuits can be prevented by separating the bare exposed parts of the connector pins corresponding to the respective intrinsically safe explosion-proof circuits even in the case of forming a plurality of intrinsically safe explosion-proof circuits by one connector connection. Thus, the plurality of intrinsically safe explosion-proof circuits can be formed using a small number of connectors.

In the above circuit forming method, a connector relay body provided with a plurality of connector connection terminals may be disposed in the hazardous area. A plurality of third connectors respectively connected to the plurality of second connectors via cables may be respectively connected to the plurality of connector connection terminals provided in the connector relay body. The connector relay body and the plurality of intrinsically safe explosion-proof related devices may be electrically connected by a cable assembly formed by bundling a plurality of wires respectively corresponding to the plurality of circuits.

In this way, the complication of wiring between the connector relay body and the intrinsically safe explosion-proof related devices can be prevented even in the case of forming the plurality of intrinsically safe explosion-proof circuits.

In the above circuit forming method, a plurality of the cables provided with identifying portions capable of identifying each may be used.

In this way, erroneous connection can be prevented using the identifying portions as marks in respectively connecting the plurality of third connectors to the connector connection terminals of the connector relay body.

In the above circuit forming method, the first connector, the second connector, the third connector and the connector relay body each including a housing made of an insulating material may be used.

In this way, it is possible to prevent shields from being grounded in each connector and the connector relay body and reliably ground the shields only at one position in the non-hazardous area.

In the above circuit forming method, at least any one of the connector relay body, the first connector, the second connector and the third connector satisfying standards of IP54 or higher may be used.

Since the intrusion of dust and moisture into the connector relay body and the connectors can be prevented in this way, the intrinsically safe explosion-proof circuits can be reliably formed.

In the above circuit forming method, the circuit may be formed by electrically connecting the electrical component disposed in the hazardous area of a hydrogen station and the intrinsically safe explosion-proof related device provided in a control board disposed in the non-hazardous area of the hydrogen station.

In this way, the intrinsically safe explosion-proof circuit can be formed by connector connection in the hydrogen station.

A hydrogen station according to the above embodiment is provided with a hazardous area and a non-hazardous area. This hydrogen station includes an electrical component to be disposed in the hazardous area, an intrinsically safe explosion-proof related device to be disposed in the non-hazardous area and configured to limit a current, a first connector electrically connected to the electrical component and a second connector to be electrically connected to the intrinsically safe explosion-proof related device and connected to the first connector in the hazardous area. A circuit in which the electrical component and the intrinsically safe explosion-proof related device are electrically connected and a current is limited by the intrinsically safe explosion-proof related device is formed by connecting the first connector and the second connector. A shielding pin provided in the first connector or the second connector is grounded only at one position in the non-hazardous area.

Since the intrinsically safe explosion-proof circuit in which the current is limited by the intrinsically safe explosion-proof related device can be formed by connector connection in this hydrogen station, man-hours in a wiring work can be reduced as compared to the case of using crimping terminals, terminal blocks or the like. Further, since the shielding pin provided in the connector is grounded only at one position in the non-hazardous area, the generation of a circulating current can be prevented unlike in the case of grounding on both ends. Thus, the generation of an arc due to the circulating current is prevented, wherefore the intrinsically safe explosion-proof circuit can be formed even in the case of using connector connection.

The above hydrogen station may include a plurality of the electrical components, a plurality of the intrinsically safe explosion-proof related devices, a plurality of the first connectors and a plurality of the second connectors. A plurality of the circuits may be formed by connecting each of the plurality of electrical components and each of the plurality of intrinsically safe explosion-proof related devices. Each of the plurality of circuits may be formed by connecting one of the plurality of first connectors and one of the plurality of second connectors.

Since a different connector connection can be used for each intrinsically safe explosion-proof circuit in this way, the shorting of the intrinsically safe explosion-proof circuits can be reliably prevented as compared to the case where a plurality of intrinsically safe explosion-proof circuits are formed by one connector connection.

The hydrogen station may include a plurality of the electrical components and a plurality of the intrinsically safe explosion-proof related devices. A plurality of the circuits may be formed by connecting each of the plurality of electrical components and each of the plurality of intrinsically safe explosion-proof related devices. The plurality of circuits may be formed by connecting one first connector and one second connector. In the first connector or the second connector, a shortest distance between bare exposed parts of the connector pins respectively corresponding to the plurality of circuits may be 6 mm or longer.

In this way, the shorting of the intrinsically safe explosion-proof circuits can be prevented by separating the bare exposed parts of the connector pins corresponding to the respective intrinsically safe explosion-proof circuits even in the case of forming a plurality of intrinsically safe explosion-proof circuits by one connector connection. Thus, the plurality of intrinsically safe explosion-proof circuits can be formed using a small number of connectors.

The above hydrogen station may further include a connector relay body provided with a plurality of connector connection terminals and disposed in the hazardous area, a plurality of third connectors to be respectively connected to the plurality of second connectors via cables and respectively connected to the plurality of connector connection terminals provided in the connector relay body and a cable assembly configured to electrically connect the connector relay body and the plurality of intrinsically safe explosion-proof related devices and formed by bundling a plurality of wires respectively corresponding to the plurality of circuits between the connector relay body and the intrinsically safe explosion-proof related devices.

In this way, the complication of wiring between the connector relay body and the intrinsically safe explosion-proof related devices can be prevented even in the case of forming the plurality of intrinsically safe explosion-proof circuits.

In the above hydrogen station, a plurality of cables for connecting the plurality of second connectors and the plurality of third connectors may be provided with identifying portions capable of identifying each.

In this way, erroneous connection can be prevented using the identifying portions as marks in respectively connecting the plurality of third connectors to the connector connection terminals of the connector relay body.

In the above hydrogen station, each of the first connector, the second connector, the third connector and the connector relay body may include a housing made of an insulating material.

In this way, it is possible to prevent shields from being grounded in the connector relay body and reliably ground the shields only at one position in the non-hazardous area.

In the above hydrogen station, at least any one of the connector relay body, the first connector, the second connector and the third connector may satisfy standards of IP54 or higher.

Since the intrusion of dust and moisture into the connector relay body and the connectors can be prevented in this way, the intrinsically safe explosion-proof circuits can be reliably formed.

This application is based on Japanese Patent application No. 2017-158420 filed in Japan Patent Office on Aug. 21, 2017, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A circuit forming method for forming a circuit in which an electrical component and an intrinsically safe explosion-proof related device are electrically connected, in a facility where the electrical component is disposed in a hazardous area and the intrinsically safe explosion-proof related device for limiting a current is disposed in a non-hazardous area, wherein
a first connector to be electrically connected to the electrical component and a second connector to be electrically connected to the intrinsically safe explosion-proof related device are connected in the hazardous area, thereby forming the circuit in which the current is limited by the intrinsically safe explosion-proof related device and grounding a shielding pin provided in the first connector or the second connector only at one position in the non-hazardous area.

2. A circuit forming method according to claim 1, wherein
each of a plurality of the circuits is formed by connecting one of a plurality of the first connectors and one of a plurality of the second connectors.

3. A circuit forming method according to claim 1, wherein
a plurality of the circuits are formed by connecting one first connector and one second connector and
the first connector or the second connector in which a shortest distance between bare exposed parts of connector pins respectively corresponding to a plurality of the circuits is 6 mm or longer is used.

4. A circuit forming method according to claim 2, wherein
a connector relay body provided with a plurality of connector connection terminals is disposed in the hazardous area,
a plurality of third connectors respectively connected to the plurality of second connectors via cables are respectively connected to the plurality of connector connection terminals provided in the connector relay body and
the connector relay body and a plurality of the intrinsically safe explosion-proof related devices are electrically connected by a cable assembly formed by bundling a plurality of wires respectively corresponding to the plurality of the circuits.

5. A circuit forming method according to claim 4, wherein
a plurality of the cables provided with identifying portions capable of identifying each are used.

6. A circuit forming method according to claim 4, wherein
the first connector, the second connector, the third connector and the connector relay body each including a housing made of an insulating material are used.

7. A circuit forming method according to claim 4, wherein
at least any one of the connector relay body, the first connector, the second connector and the third connector satisfying standards of IP54 or higher is used.

8. A circuit forming method according to claim 1, wherein
the circuit is formed by electrically connecting the electrical component disposed in the hazardous area of a hydrogen station and the intrinsically safe explosion-proof related device provided in a control board disposed in the non-hazardous area of the hydrogen station.

9. A hydrogen station provided with a hazardous area and a non-hazardous area, comprising:
an electrical component to be disposed in the hazardous area;
an intrinsically safe explosion-proof related device to be disposed in the non-hazardous area and configured to limit a current;
a first connector electrically connected to the electrical component; and
a second connector to be electrically connected to the intrinsically safe explosion-proof related device and connected to the first connector in the hazardous area;
wherein
a circuit in which the electrical component and the intrinsically safe explosion-proof related device are electrically connected and a current is limited by the intrinsically safe explosion-proof related device is formed by connecting the first connector and the second connector and
a shielding pin provided in the first connector or the second connector is grounded only at one position in the non-hazardous area.

10. A hydrogen station according to claim 9, comprising:
a plurality of the electrical components, a plurality of the intrinsically safe explosion-proof related devices, a plurality of the first connectors and a plurality of the second connectors, wherein
a plurality of the circuits are formed by connecting each of the plurality of electrical components and each of the plurality of intrinsically safe explosion-proof related devices and
each of the plurality of circuits is formed by connecting one of the plurality of first connectors and one of the plurality of second connectors.

11. A hydrogen station according to claim 9, comprising:
a plurality of the electrical components and a plurality of the intrinsically safe explosion-proof related devices, wherein
a plurality of the circuits are formed by connecting each of the plurality of electrical components and each of the plurality of intrinsically safe explosion-proof related devices,
the plurality of circuits are formed by connecting one first connector and one second connector and
a shortest distance between bare exposed parts of connector pins respectively corresponding to the plurality of circuits is 6 mm or longer in the first connector or the second connector.

12. A hydrogen station according to claim 10, further comprising:
a connector relay body provided with a plurality of connector connection terminals and disposed in the hazardous area;
a plurality of third connectors to be respectively connected to the plurality of second connectors via cables and respectively connected to the plurality of connector connection terminals provided in the connector relay body and
a cable assembly configured to electrically connect the connector relay body and the plurality of intrinsically safe explosion-proof related devices and formed by bundling a plurality of wires respectively corresponding to the plurality of circuits between the connector relay body and the intrinsically safe explosion-proof related devices.

13. A hydrogen station according to claim 12, wherein
a plurality of the cables for connecting the plurality of second connectors and the plurality of third connectors are provided with identifying portions capable of identifying each.

14. A hydrogen station according to claim 12, wherein
each of the first connector, the second connector, the third connector and the connector relay body includes a housing made of an insulating material.

15. A hydrogen station according to claim 12, wherein
at least any one of the connector relay body, the first connector, the second connector and the third connector satisfies standards of IP54 or higher.
